(19) United States
(12) Patent Application Publication
(10) Pub. No.: US 2008/0260272 A1
(43) Pub. Date: Oct. 23, 2008

(54) IMAGE CODING DEVICE, IMAGE CODING METHOD, AND IMAGE DECODING DEVICE

(75) Inventor: Takahisa Wada, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/104,838

(22) Filed: Apr. 17, 2008

(30) Foreign Application Priority Data
Apr. 18, 2007 (JP) 2007-109581

(51) Int. Cl. G06K 9/46; G06K 9/36

(52) U.S. Cl. 382/239; 382/250

(57) ABSTRACT

An image coding device includes a block dividing unit that divides image data into blocks, so as to generate block data, each of the blocks being formed with a plurality of pixels, a DCT unit that carries out a discrete cosine transform on the block data, so as to generate DCT coefficients, a feature analyzing unit that analyzes the block data, so as to generate feature data, a quantization parameter generating unit that refers to the block data and the feature data, and generates a quantization matrix, a quantizing unit that quantizes the DCT coefficients with the use of the quantization matrix, so as to generate quantized data, and a variable-length coding unit that performs variable-length coding on the quantized data, so as to generate variable-length coded data.

### CROSS-REFERENCE TO RELATED APPLICATION

This application is based upon and claims the benefit of priority from the prior Japanese Patent Application No. 2007-109581, filed on Apr. 18, 2007; the entire contents of which are incorporated herein by reference.

### BACKGROUND OF THE INVENTION

The present invention relates to an image coding device, image coding method, and an image decoding device. More particularly, the present invention relates to an image coding device that performs compression coding by quantizing image data in accordance with the features of a subject image, an image coding method that is used in the image coding device, and an image decoding device that decodes data coded by the image coding device.

Conventionally, there have been block coding methods, such as block DCT (discrete cosine transform) coding, known as the coding methods for performing efficient compression coding on image data of a moving picture or a still picture or the like.

When image data compression/expansion is performed by one of such block coding methods, block deformation is easily caused at a higher compression rate. Since a transform is carried out in a closed space in a block, correlations beyond the block boundaries are not taken into consideration. As a result, continuity cannot be maintained at the boundary region between each two adjacent blocks, and a difference is caused between reproduced data values. The difference is sensed as deformation. If high-frequency components are removed to increase the compression rate, continuity cannot be maintained at the boundary region between each two adjacent blocks, and block deformation is also caused in this case. Since the block deformation has a kind of regularity, it is easier to sense the deformation than general random noises. The block deformation is a major cause of image quality degradation at the time of compression.

To counter the image quality degradation at the time of compression, US-2004/0032987 discloses a method by which the features of blocks are analyzed based on original image data and DCT results, and optimum ones are selected from predetermined quantization matrixes, so as to perform quantization.

By this method, however, the quantization matrixes are determined in advance, and cannot be dynamically changed. Also, if a large number of quantization matrixes are prepared for each block, a large amount of coding is required to perform coding on those quantization matrixes, and the compression rate cannot be increased.

This problem is now described in detail, with MPEG (Moving Pictures Experts Group) being taken as an example of an image data block coding method. In MPEG, DCT transforms utilizing the intra correlations, motion compensations utilizing the inter correlations, and Huffman coding utilizing the correlations between code strings are combined. The high-frequency components are removed from the spatial frequency of image data through weighted quantization, so as to realize compression. Accordingly, where the compression rate is to be increased, the corresponding high-frequency components are removed. As a result, block deformation is easily caused.

### SUMMARY OF THE INVENTION

According to a first aspect of the present invention, there is provided that an image coding device comprising:

a block dividing unit that divides image data into blocks, so as to generate block data, each of the blocks being formed with a plurality of pixels;

a DCT unit that carries out a discrete cosine transform on the block data, so as to generate DCT coefficients;

a feature analyzing unit that analyzes the block data, so as to generate feature data;

a quantization parameter generating unit that refers to the block data and the feature data, and generates a quantization matrix;

a quantizing unit that quantizes the DCT coefficients with the use of the quantization matrix, so as to generate quantized data; and

a variable-length coding unit that performs variable-length coding on the quantized data, so as to generate variable-length coded data.

According to a second aspect of the present invention, there is provided that an image coding method comprising:

generating block data by dividing image data into blocks, each of the blocks being structured with a plurality of pixels;

generating DCT coefficients by carrying out a discrete cosine transform on the block data;

generating feature data by analyzing the block data;

generating a quantization matrix, with reference to the block data and the feature data;

generating quantized data by quantizing the DCT coefficients with the use of the quantization matrix; and

generating variable-length coded data by performing variable-length coding on the quantized data.

According to a third aspect of the present invention, there is provided that an image decoding device comprising:

a decoding unit that decodes variable-length coded data, so as to generate quantized data and conversion parameters;

an inverse quantizing unit that performs inverse quantization on the quantized data with the use of a first quantization matrix, so as to generate first DCT coefficients;

an inverse DCT unit that carries out an inverse discrete cosine transform on the first DCT coefficients, so as to generate first block data;

a feature analyzing unit that analyzes the first block data, and generates feature data; and

a quantization parameter generating unit that refers to the first block data, the feature data, and the conversion parameters, and generates a second quantization matrix,

the inverse quantizing unit performing inverse quantization on the quantized data with the use of the second quantization matrix,

the inverse DCT unit carrying out an inverse discrete cosine transform on the second DCT coefficients, so as to generate second block data.

### BRIEF DESCRIPTION OF THE DRAWINGS

FIG. 1 is a block diagram showing the architecture of an image coding and encoding system 1 in accordance with the first embodiment of the present invention.

FIG. 2 is a block diagram showing the architecture of the image coding device 100 in accordance with the first embodiment of the present invention.

FIG. 3 is a block diagram showing the architecture of the quantization parameter generating unit 110 in accordance with the first embodiment of the present invention.

FIG. 4 is a flowchart showing the procedures carried out by the image coding device 100 in a variable-length coding processing in accordance with the first embodiment of the present invention.

FIG. 5(a) is a diagrammatic illustration showing the block data of the variable-length coding and variable-length decoding.

FIG. 5(b) is a diagrammatic illustration showing the block data replaced with white pixels.

FIG. 5(c) is a diagrammatic illustration showing the DCT coefficients.

FIG. 5(d) is a diagrammatic illustration showing the quantization matrix obtained prior to the conversion.

FIG. 5(e) is a diagrammatic illustration showing the converted quantization matrix.

FIG. 6 is a block diagram showing the architecture of an image coding device 100 in accordance with the second embodiment of the present invention.

FIG. 7 is a flowchart showing the procedures to be carried out by the image coding device 100 in a variable-length coding processing when a compression-first mode is set in accordance with the second embodiment of the present invention.

FIG. 8 is a flowchart showing the procedures to be carried out by the image coding device 100 in a variable-length coding processing when a quality-first mode is set in accordance with the second embodiment of the present invention.

FIG. 9 is a block diagram showing the architecture of the image decoding device 200 in accordance with the third embodiment of the present invention.

FIG. 10 is a flowchart showing the procedures to be carried out by the image decoding device 200 in a variable-length decoding processing in accordance with the third embodiment of the present invention.

### DETAILED DESCRIPTION OF THE INVENTION

The following is a description of embodiments of the present invention, with reference to the accompanying drawings. The embodiments described below are merely examples of embodiments of the present invention, and the present invention is not limited to them.

### First Embodiment

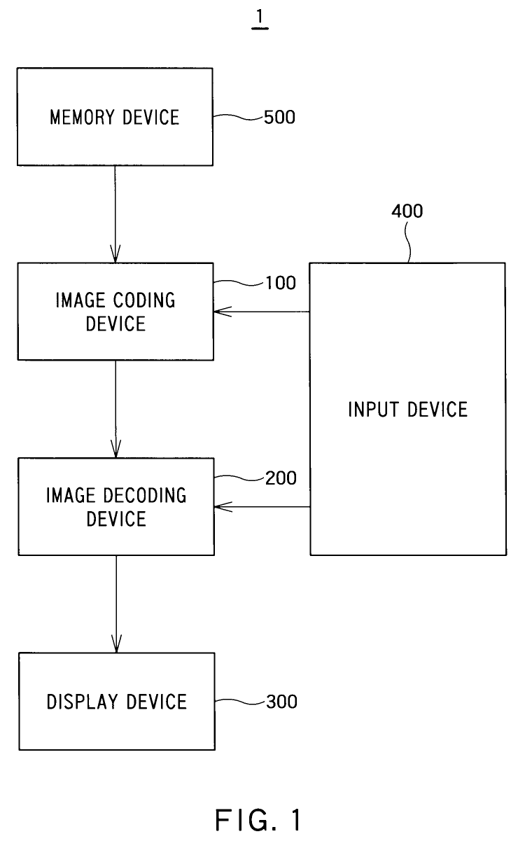

A first embodiment of the present invention is now described. FIG. 1 is a block diagram showing the architecture of an image coding and encoding system 1 in accordance with the first embodiment of the present invention. The image coding and decoding system 1 in accordance with the first embodiment of the present invention comprises an image coding device 100, an image decoding device 200, a display device 300, an input device 400, and a memory device 500.

Image data of still pictures, moving pictures, and the likes are stored beforehand in the memory device 500. The input device 400 outputs an instruction from a user to the image coding device 100 or the image decoding device 200. In accordance with the instruction output from the input device 400, the image coding device 100 reads image data from the memory device 500, performs compression coding on the image data, and outputs variable-length coded data to the image decoding device 200. In accordance with the instruction output from the input device 400, the image decoding device 200 receives the variable-length coded data output from the image coding device 100, decodes and expands the variable-length coded data, and outputs the later described block data to the display device 300. The display device 300 receives the block data output from the image decoding device 200, and displays an image. The image coding device 100 and the image decoding device 200 may form different systems from each other.

For example, the display device 300 may be an image display device such as a liquid crystal display. The input device 400 may be an input device such as a keyboard. The memory device 500 may be a computer-readable recording medium such as a hard disk. The image coding device 100 and the image decoding device 200 will be described later in detail.

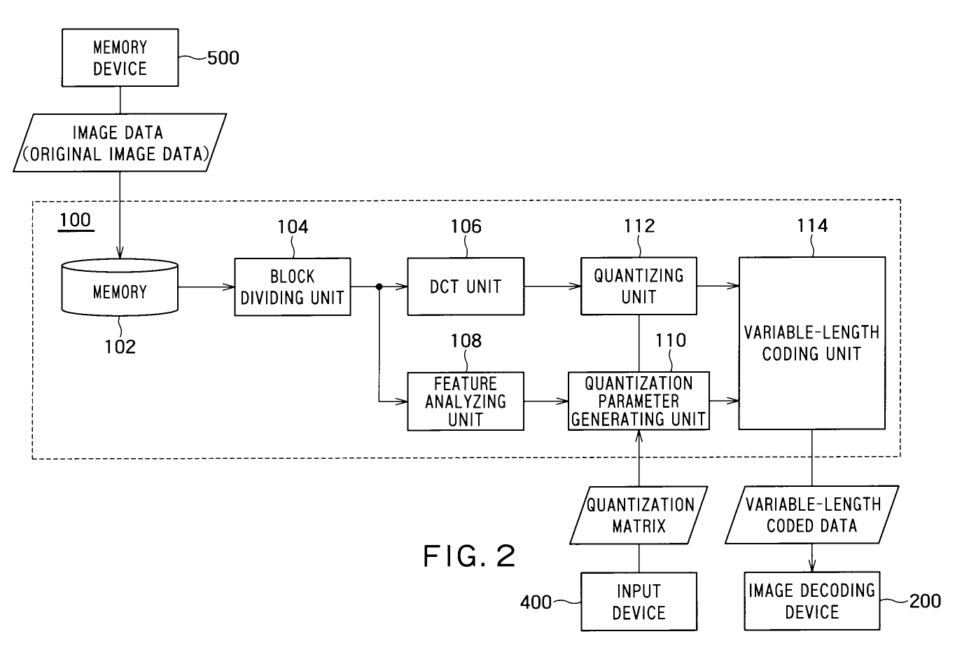

FIG. 2 is a block diagram showing the architecture of the image coding device 100 in accordance with the first embodiment of the present invention. The image coding device 100 in accordance with the first embodiment of the present invention comprises a memory 102, a block dividing unit 104, a DCT unit 106, a feature analyzing unit 108, a quantization parameter generating unit 110, a quantizing unit 112, and a variable-length coding unit 114.

The memory 102 stores image data (original image data) that is read from the memory device 500.

The block dividing unit 104 reads the image data (the original image data) stored in the memory 102. The block dividing unit 104 then divides the image data into unit blocks each consisting of 8×8 pixels, so as to generate the block data. The block dividing unit 104 then outputs the block data to the DCT unit 106 and the feature analyzing unit 108. Alternatively, the block dividing unit 104 may divide the image data into unit blocks other than 8×8 (such as 4×4 pixels).

The DCT unit 106 receives the block data output from the block dividing unit 104. The DCT unit 106 then performs discrete cosine transform (DCT) on the block data, so as to generate discrete cosine coefficients (DCT coefficients). The DCT unit 106 then outputs the DCT coefficients to the quantizing unit 112.

The feature analyzing unit 108 receives the block data output from the block dividing unit 104, and analyzes the feature of the block data. The feature analyzing unit 108 then adds the feature data (the types of features and location information) as the analysis results to the block data, and outputs the feature data and the block data to the quantization parameter generating unit 110. Here, the types of features include an edge type, a texture type, a skin-color type, and the likes. The location information indicates the coordinates of the feature pixels in the block data.

The quantization parameter generating unit 110 receives the block data that has the feature data added thereto and is output from the feature analyzing unit 108. The quantization parameter generating unit 110 then converts and optimizes the value (step size) of the quantization matrix coefficient of the quantization matrix that is output from the input device 400 referring to the feature data. The quantization parameter generating unit 110 outputs the converted quantization matrix to the quantizing unit 112, and also outputs the quantization matrix obtained prior to the conversion and the conversion parameter used for optimizing the step size to the variable-length coding unit 114. The quantization parameter generating unit 110 will be described later in detail.

The quantizing unit 112 receives the DCT coefficients that are output from the DCT unit 106, and the converted quantization matrix that is output from the quantization parameter generating unit 110. The quantizing unit 112 quantizes each value of the DCT coefficients with the use of the converted quantization matrix, so as to generate quantized data. The quantizing unit 112 then outputs the quantized data to the variable-length coding unit 114.

The variable-length coding unit 114 receives the conversion parameter that is output from the quantization parameter generating unit 110, and the quantized data that is output from the quantizing unit 112. The variable-length coding unit 114 performs variable-length coding on the quantization matrix obtained prior to the conversion, the conversion parameter, and the quantized data, so as to generate variable-length coded data. The variable-length coding unit 114 then outputs the variable-length coded data to the image decoding device 200.

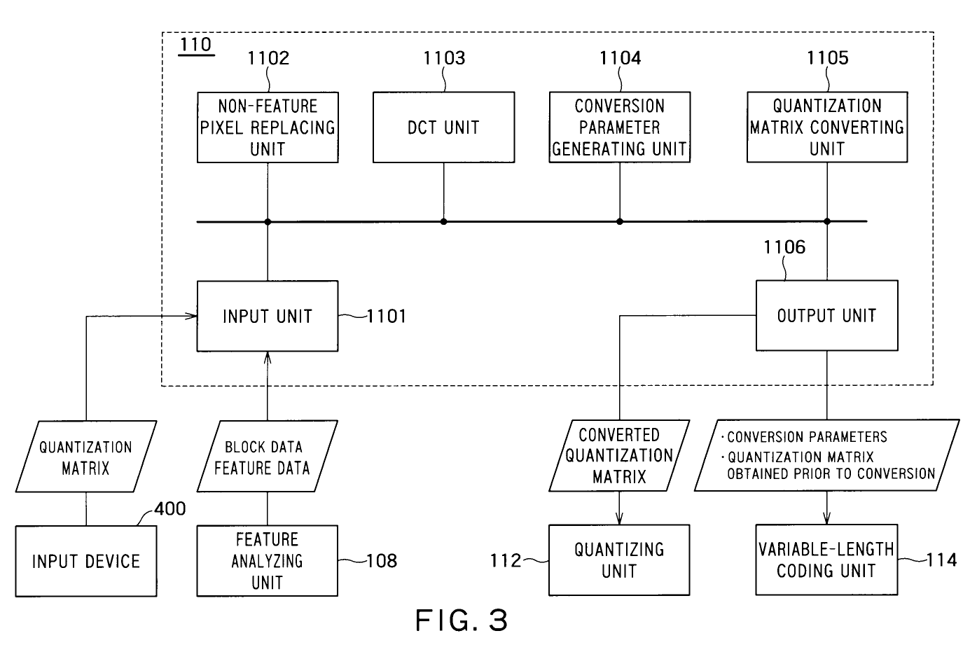

FIG. 3 is a block diagram showing the architecture of the quantization parameter generating unit 110 in accordance with the first embodiment of the present invention. The quantization parameter generating unit 110 in accordance with the first embodiment of the present invention comprises an input unit 1101, a non-feature pixel replacing unit 1102, a DCT unit 1103, a conversion parameter generating unit 1104, a quantization matrix converting unit 1105, and an output unit 1106.

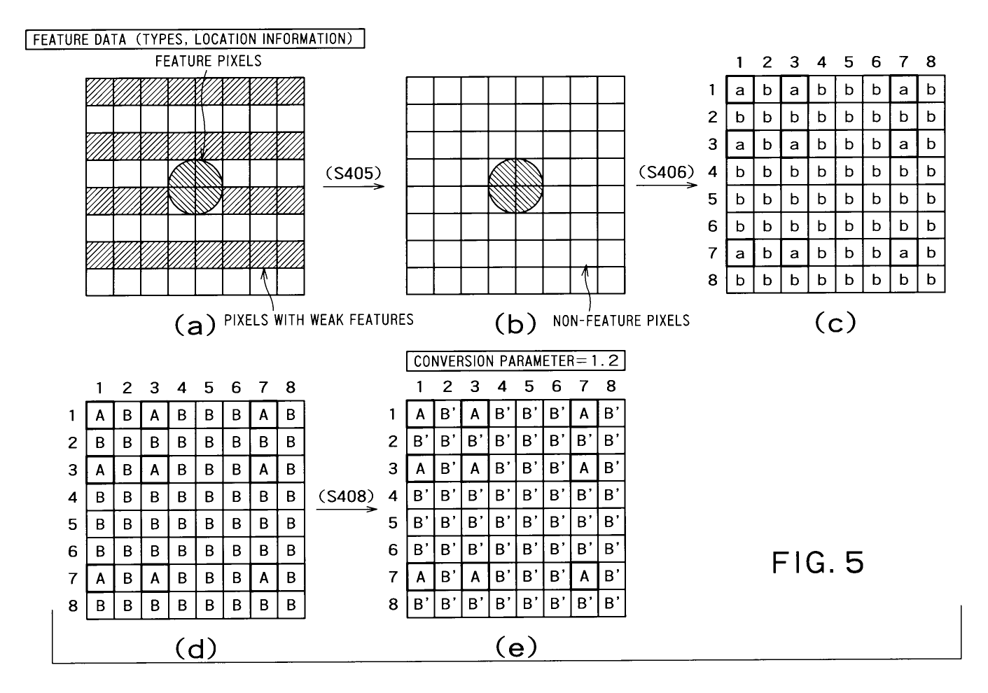

The input unit 1101 receives the block data that is output from the feature analyzing unit 108 and has the feature data added thereto (see FIG. 5(a)), and the quantization matrix that is output from the input device 400 (see FIG. 5(d)).

The non-feature pixel replacing unit 1102 refers to the location information about the feature data, and replaces the pixels that are not indicated in the location information (the pixels that are not feature pixels) among the pixels in the block data with non-feature pixels (such as white pixels) (see FIG. 5(b)). The non-feature pixel replacing unit 1102 performs processing so as to define the feature portions in DCT coefficients that are generated by the later described DCT unit 1103.

The DCT unit 1103 performs DCT on the block data replaced by the non-feature pixel replacing unit 1102, so as to generate the DCT coefficients (see FIG. 5(c)).

Based on the feature quantity (such as the edge intensity) of the original image data, the conversion parameter generating unit 1104 selects a predetermined number (n) of coefficients (the nine “a”s in FIG. 5(c)) from the coefficients having large absolute values among the DCT coefficients generated by the DCT unit 1103. The conversion parameter generating unit 1104 determines that the selected n coefficients as the coefficient representing the feature of the block data, and determines that the unselected coefficients (the 72 “b”s in FIG. 5(c)) are the quantization matrix coefficients to be optimized in the quantization matrix. The conversion parameter generating unit 1104 then generates conversion parameters that include the number of the quantization matrix coefficients to be optimized (“72” in FIG. 5(e)) and the optimization coefficient for optimizing the quantization matrix coefficients (“1.2” in FIG. 5(e)). Here, the conversion parameter generating unit 1104 generates a value larger than “1” as the optimization coefficient, so as to increase the compression rate.

The conversion parameter generating unit 1104 may determine that all the DCT coefficients generated by the DCT unit 1103 are the quantization matrix coefficients to be optimized. In that case, the conversion parameter generating unit 1104 generates a value lager than “1” (“1.2”, for example) as the optimization coefficients for the unselected coefficients, so as to increase the compression rate. The conversion parameter generating unit 1104 generates a value smaller than “1” (“0.7”, for example) as the optimization coefficient for the selected n coefficients, so as to improve the decoded image quality.

The quantization matrix converting unit 1105 refers to the conversion parameters generated by the conversion parameter generating unit 1104, and performs a converting processing by multiplying the quantization matrix coefficients of the quantization matrix input to the input unit 1101 by the optimum coefficient (see FIG. 5(e)). Here, as the number of quantization matrix coefficients to be optimized and the optimization coefficient are larger, the compression rate in the quantization by the quantizing unit 112 is higher. Meanwhile, as the number of quantization matrix coefficients to be optimized and the optimization coefficient are smaller, the image quality of image data decoded by the decoding device 200 is higher.

The output unit 1106 outputs the quantization matrix output from the input device 400 and the conversion parameters generated by the conversion parameter generating unit 1104 to the variable-length coding unit 114, and also outputs the quantization matrix converted by the quantization matrix converting unit 1105 to the quantizing unit 112.

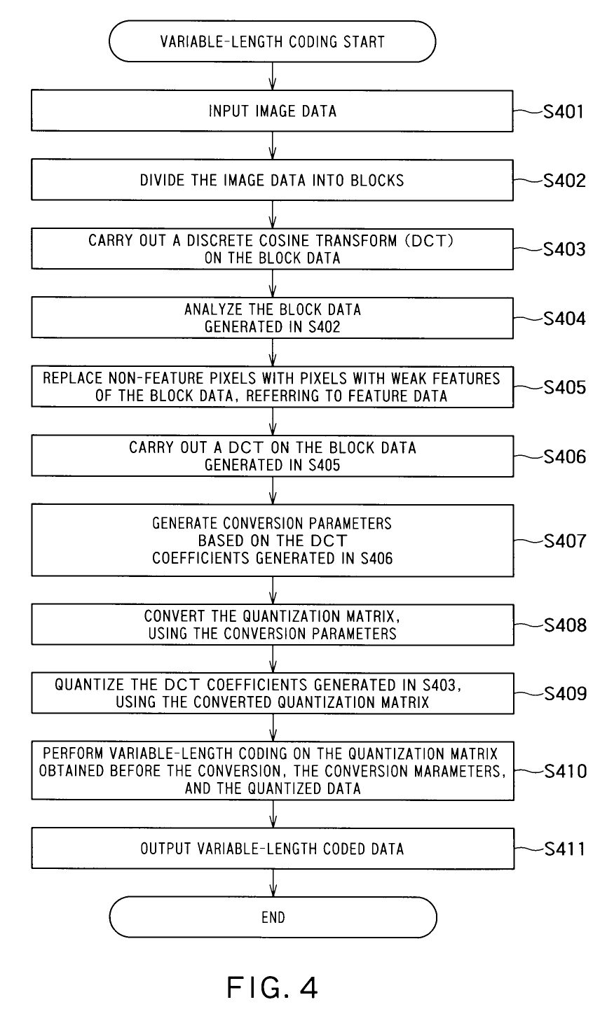

FIG. 4 is a flowchart showing the procedures carried out by the image coding device 100 in a variable-length coding processing in accordance with the first embodiment of the present invention.

First, the image coding device 100 reads and inputs image data (original image data) from the memory device 500, and stores the image data in the memory 102 (S401). Then, the block dividing unit 104 reads the image data (the original image data) that is stored in the memory 102 in step S401, and divides the image data into unit blocks each consisting of 8×8 pixels, so as to generate block data shown in FIG. 5(a) (S402).

Then, the DCT unit 106 carries out a discrete cosine transform (DCT) on the block data generated in step S402, so as to generate discrete cosine coefficients (DCT coefficients) (S403). Then, the feature analyzing unit 108 analyzes the features (edge types, texture types, skin-color types, and the likes) of the block data generated in step S402, and adds feature data (the types of features and the location information) that is the analysis results to the block data (S404).

Then, the non-feature pixel replacing unit 1102 of the quantization parameter generating unit 110 refers to the feature data added in step S404. The non-feature pixel replacing unit 1102 then replaces pixels having weak features among the block data with non-feature pixels such as white pixels, so as to generate the block data shown in FIG. 5(b) (S405). Then, the DCT unit 1103 of the quantization parameter generating unit 110 carries out a DCT on the block data generated in step S405 (the block data having the feature data added thereto and the weak-feature pixels replaced with the non-feature pixels), so as to generate the DCT coefficients shown in FIG. 5(c) (S406).

Then, based on the DCT coefficients generated in step S406, the conversion parameter generating unit 1104 of the quantization parameter generating unit 110 generates the conversion parameters for converting the quantization matrix that is output from the input device 400 (see FIG. 5(d)) (S407). Here, the specifics of the processing to be performed by the conversion parameter generating unit 1104 have been described above, with reference to FIG. 3.

Then, the quantization matrix converting unit 1105 of the quantization parameter generating unit 110 converts the quantization matrix into the matrix shown in FIG. 5(e), using the conversion parameters generated in step S407 (S408). Here, the specifics of the processing to be performed by the quantization matrix converting unit 1105 have been described above, with reference to FIG. 3.

As shown in FIG. 5(d), the quantization matrix obtained prior to the conversion is formed with quantization matrix coefficients A not to be optimized and quantization matrix coefficients B to be optimized. As shown in FIG. 5(e), the converted quantization matrix is formed with the quantization matrix coefficients A that have not been optimized, and quantization matrix coefficients B′ that have been optimized. When the conversion parameter is 1.2, each quantization matrix coefficient B′ is 1.2B. In FIGS. 5(d) and 5(e), the quantization matrix coefficients in the respective positions (on the nth row of the nth column) are not necessarily the same values (for example, the quantization matrix coefficient A on the first row of the first column is not necessarily the same as the quantization matrix coefficient A on the first row of the third column).

Then, using the quantization matrix converted in step S408 (see FIG. 5(e)), the quantizing unit 112 quantizes the DCT coefficients generated in step S403, so as to generate the quantized data (S409). Then, the variable-length coding unit 114 then performs variable-length coding on the quantization matrix obtained prior to the conversion (see FIG. 5(d)), the conversion parameters generated in step S407 (see FIG. 5(e)), and the quantized data generated in step S409, so as to generate the variable-length coded data (S410). Then, the image coding device 100 outputs the variable-length coded data generated in step S410 to the image decoding device 200, and ends the variable-length coding processing in accordance with the first embodiment of the present invention (S411).

In accordance with the first embodiment of the present invention, each quantization matrix is converted so as to maintain the features of the block data. Accordingly, image quality degradation is prevented at the time of compression, and the image data compression rate can be made higher. Also, in accordance with the first embodiment of the present invention, variable-length coded data is generated based only on the quantization matrix obtained prior to the conversion, the conversion parameters, and the quantized data. Accordingly, there is no need to perform variable-length coding on the quantization matrix of each set of block data, and the data amount of variable-length coded data can be made smaller.

### Second Embodiment

Next, a second embodiment of the present invention is described. In addition to the specifics of the first embodiment of the present invention, the second embodiment of the present invention describes that it has a function of checking whether the features of original image data are not lost when quantized data is decoded. Explanation of the aspects that are the same as those of the first embodiment of the present invention is omitted here.

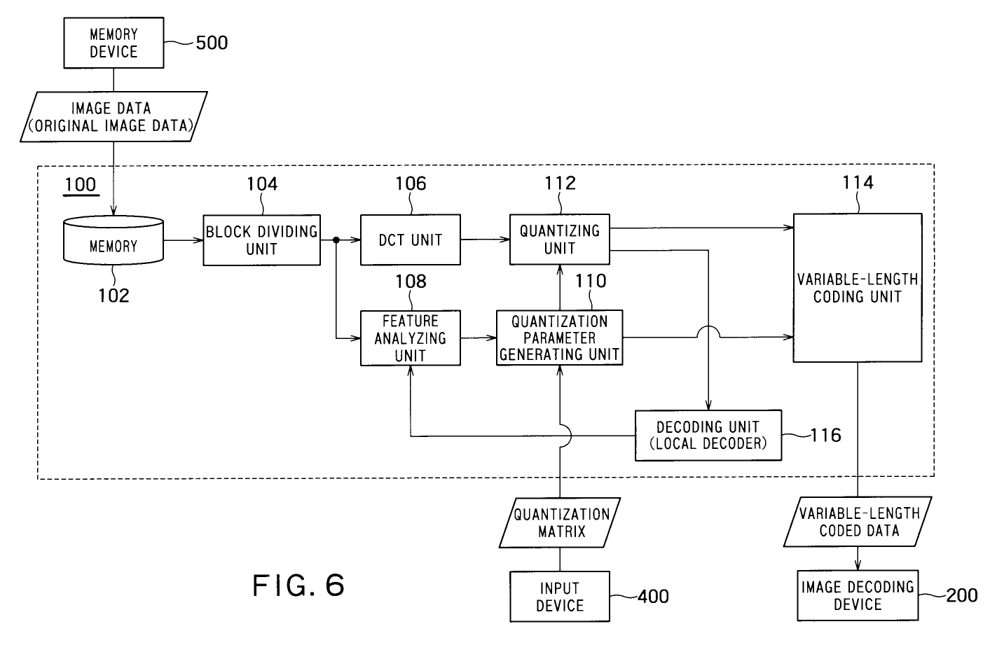

FIG. 6 is a block diagram showing the architecture of an image coding device 100 in accordance with the second embodiment of the present invention. The image coding device 100 in accordance with the second embodiment of the present invention further comprises a decoding unit (a local decoder) 116, as well as the same components as those of the image coding device 100 of the first embodiment of the present invention.

The quantizing unit 112 generates quantized data, and outputs the quantized data to the decoding unit (the local decoder) 116. In a case where the later described analysis results obtained by the feature analyzing unit 108 are within a predetermined range, the quantizing unit 112 outputs the generated quantized data to the variable-length coding unit 114.

The decoding unit (the local decoder) 116 inputs the quantized data that is output from the quantizing unit 112, and performs inverse quantization on the quantized data, so as to generate DCT coefficients. The decoding unit (the local decoder) 116 then carries out an inverse DCT on the DCT coefficients, so as to generate block data. The decoding unit (the local decoder) 116 outputs the block data to the feature analyzing unit 108.

The feature analyzing unit 108 receives the block data that is output from the decoding unit (the local decoder) 116, analyzes the features of the block data, determines whether the features of the two sets of block data are the same, and outputs the determination result to the quantization parameter generating unit 110. The feature analyzing unit 108 may be structured to determine the features of the two sets of block data are “the same”, if the amount of the difference between the two sets of block data is within a predetermined range.

The quantization parameter generating unit 110 receives the determination result that is output from the feature analyzing unit 108. If the determination result indicates “not the same”, the quantization parameter generating unit 110 modifies the conversion parameters, and again carries out a conversion on the quantization matrix with the use of the modified conversion parameter. The quantization parameter generating unit 110 then outputs the converted quantization matrix to the quantizing unit 112. If the determination result indicates “the same”, the quantization parameter generating unit 110 outputs the quantization matrix and the conversion parameters obtained prior to the conversion to the variable-length coding unit 114.

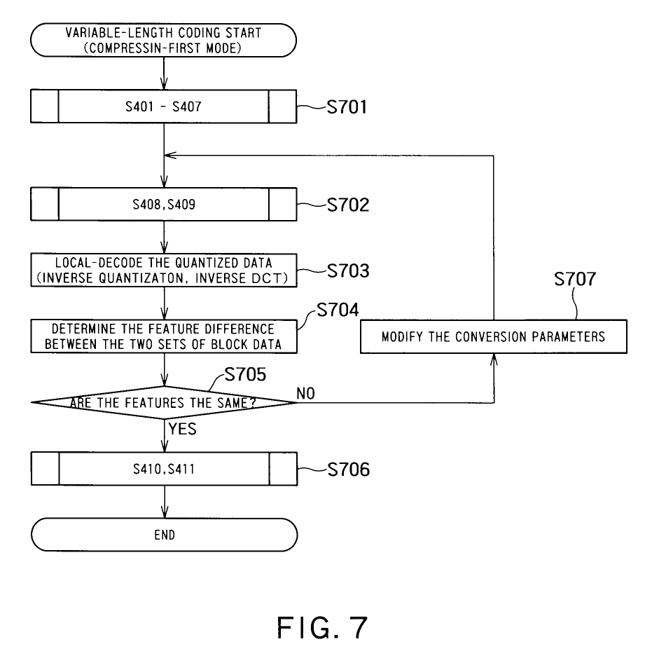

FIG. 7 is a flowchart showing the procedures to be carried out by the image coding device 100 in a variable-length coding processing when a compression-first mode is set in accordance with the second embodiment of the present invention.

First, the same procedures as those of steps S401 through S407 of FIG. 4 are carried out (S701). Here, the conversion parameters are generated so as to maximize the compression rate (increase the value of the optimization coefficient) in step S407 of FIG. 4. Then, the same procedures as those of steps S408 and S409 of FIG. 4 are carried out (S702).

Then, the decoding unit (the local decoder) 116 performs inverse quantization and carries out an inverse DCT (local decoding) on the quantized data that is generated in step S409 of FIG. 4, so as to generate block data (S703). Then, the feature analyzing unit 108 compares the features of the block data generated in step S402 of FIG. 4 with the features of the block data generated in step S703, so as to determine the difference between the two sets of block data (S704).

If the determination result of step S704 indicates “the same” (“YES” in step S705), the variable-length coding unit 114 carries out the same procedures as those of steps S410 and S411 of FIG. 4, and ends the variable-length coding processing in the compression-first mode in accordance with the second embodiment of the present invention (S706).

Meanwhile, if the determination result of step S704 indicates “not the same” (“NO” in step S705), the quantization parameter generating unit 110 modifies the conversion parameters so as to reduce the compression rate (reduce the value of the optimization coefficient) (S707). The processing then returns to step S702.

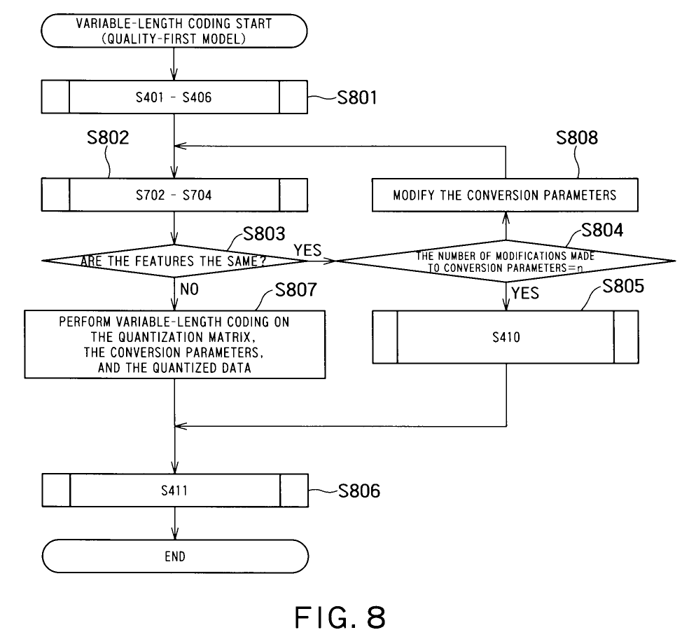

FIG. 8 is a flowchart showing the procedures to be carried out by the image coding device 100 in a variable-length coding processing when a quality-first mode is set in accordance with the second embodiment of the present invention.

First, the same procedures as those of steps S401 through S407 of FIG. 4 are carried out (S801). Here, in step S407 of FIG. 4, the conversion parameters are generated so as to obtain a compression rate within a desired range that guarantees good image quality. Then, the same procedures as those of steps S702 through S704 of FIG. 7 are carried out (S802).

If the determination result of step S704 of FIG. 7 indicates “the same” (“YES” in step S803), and the number of modifications made to the conversion parameters has reached a predetermined number (n) of times (“YES” in step S804), the variable-length coding unit 114 carries out the same procedure as that of step S410 of FIG. 4 (S805). Then, the variable-length coding unit 114 carries out the same procedure as that of step S411 of FIG. 4, and ends the variable-length coding processing in the quality-first mode in accordance with the second embodiment of the present invention (S806).

If the determination result of step S704 of FIG. 7 indicates “not the same” (“NO” in step S803), the variable-length coding unit 114 performs variable-length coding on the quantization matrix obtained prior to the conversion, the conversion parameters obtained prior to the modification (prior to the procedure of step S808), and the quantized data corresponding to the conversion parameters obtained prior to the modification (the quantized data generated with the use of the quantization matrix converted based on the conversion parameters obtained prior to the modification) (S807). The variable-length coding unit 114 then carries out the same procedure as that of step S411 of FIG. 4, and ends the variable-length coding processing in the quality-first mode in accordance with the second embodiment of the present invention (S806).

Meanwhile, if the determination result of step S704 of FIG. 7 indicates “the same” (“YES” in step S803), but the number of modifications made to the conversion parameters is less than the predetermined number (n) of times (“NO” in step S804), the quantization parameter generating unit 110 modifies the conversion parameters so as to increase the compression rate (increase the value of the optimization coefficient) (S808), and the processing returns to step S802.

The compression-first mode or the quality-first mode is set in accordance with a user instruction that is input to the input device 400 shown in FIG. 1. Also, the maximum number (n) of modifications that can be made to the conversion parameters in the quality-first mode is set in accordance with a user instruction that is input to the input device 400 shown in FIG. 1. The compression rate becomes higher within the image-quality guaranteeing range, as the value n becomes larger. The speed of the variable-length coding processing becomes higher, as the value n becomes smaller.

The same effects as those of the first embodiment of the present invention can be achieved by the second embodiment of the present invention. Furthermore, in accordance with the second embodiment of the present invention, the compression rate can be made even higher, as the conversion parameters are modified so as to obtain a high compression rate within a range that guarantees the same features between image data and original image data. Furthermore, in accordance with the second embodiment of the present invention, each user can obtain a desired combination of image quality and a compression rate, as the compression-first mode or the quality-first mode can be selected when conversion parameters are generated.

### Third Embodiment

Next, a third embodiment of the present invention is described. Although the image coding device 100 has been described in the above descriptions of the first and second embodiments of the present invention, the image decoding device 200 is described in the following description of the third embodiment of the present invention.

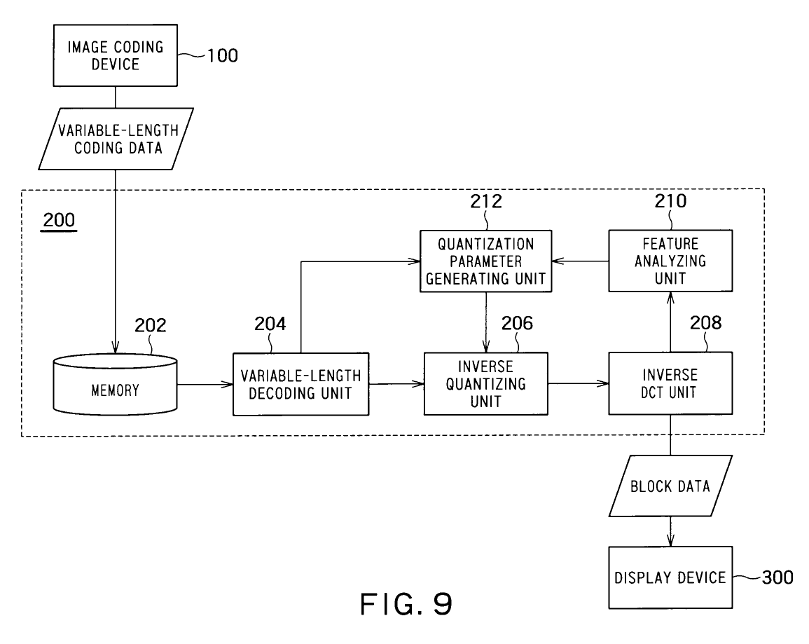

FIG. 9 is a block diagram showing the architecture of the image decoding device 200 in accordance with the third embodiment of the present invention. The image decoding device 200 in accordance with the third embodiment of the present invention includes a memory 202, a variable-length decoding unit 204, an inverse quantizing unit 206, an inverse DCT unit 208, a feature analyzing unit 210, and a quantization parameter generating unit 212.

The memory 202 receives variable-length coded data that is output from the image coding device 100.

The variable-length decoding unit 204 reads the variable-length coded data stored in the memory 202, and decodes the variable-length coded data, so as to generate the quantization matrix obtained prior to a conversion (see FIG. 5(d)), conversion parameters, and quantized data. The variable-length decoding unit 204 outputs the conversion parameters to the quantization parameter generating unit 212, and outputs the quantized data to the inverse quantizing unit 206. The variable-length decoding unit 204 also outputs the quantization matrix to the quantization parameter generating unit 212 and the inverse quantizing unit 206.

The inverse quantizing unit 206 receives the quantized data that is output from the variable-length decoding unit 204. Using the quantization matrix, the inverse quantizing unit 206 performs inverse quantization on the quantized data, so as to generate DCT coefficients. The inverse quantizing unit 206 then outputs the DCT coefficients to the inverse DCT unit 208.

The inverse DCT unit 208 receives the DCT coefficients that are output from the inverse quantizing unit 206, and carries out an inverse discrete cosine transform (an inverse DCT) on the DCT coefficients, so as to generate block data. The inverse DCT unit 208 then outputs the block data to the feature analyzing unit 210 or the display device 300.

The feature analyzing unit 210 receives the block data that is output from the inverse DCT unit 208, and analyzes the features of the block data. The feature analyzing unit 210 adds feature data (the types of features and location information) that is the analysis results to the block data, and outputs the block data with the feature data to the quantization parameter generating unit 212. Here, the types of features include an edge type, a texture type, a skin color type, and the likes. The location information indicates the coordinates of the feature pixels in the block data.

The quantization parameter generating unit 212 receives the block data with the feature data that is output from the feature analyzing unit 210. Based on the feature data, the quantization parameter generating unit 212 detects the quantization matrix coefficients to be optimized among the quantization matrix coefficients in the quantization matrix obtained prior to a conversion (see FIG. 5(d)). The quantization parameter generating unit 212 also refers to the conversion parameters that are output from the variable-length decoding unit 204, and carries out a conversion by multiplying each of the quantization matrix coefficients in the quantization matrix obtained prior to a conversion by the optimization coefficient. The quantization parameter generating unit 112 then outputs the converted quantization matrix (see FIG. 5(e)) to the inverse quantizing unit 206.

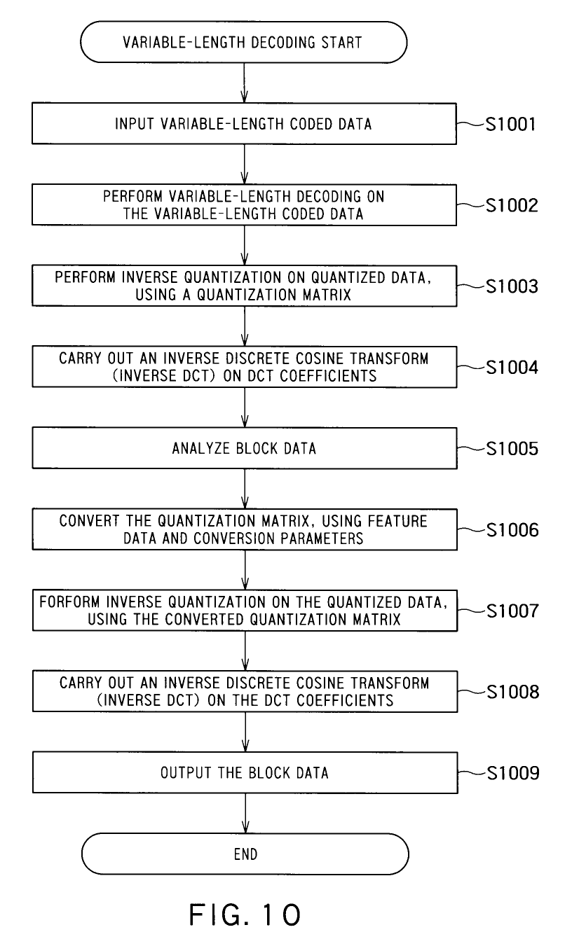

FIG. 10 is a flowchart showing the procedures to be carried out by the image decoding device 200 in a variable-length decoding processing in accordance with the third embodiment of the present invention.

First, the image decoding device 200 receives variable-length coded data from the image coding device 100, and stores the variable-length coded data in the memory 202 (S1001). Then, the variable-length decoding unit 204 reads the variable-length coded data from the memory 202, and decodes the variable-length coded data, so as to generate the quantization matrix obtained prior to a conversion (see FIG. 5(d)), the conversion parameters, and the quantized data (S1002).

Then, using the quantization matrix obtained prior to a conversion (see FIG. 5(d)) generated in step S1002, the inverse quantizing unit 206 performs inverse quantization on the quantized data generated in step S1002, so as to generate DCT coefficients (S1003). Then, the inverse DCT unit 208 carries out an inverse discrete cosine transform (an inverse DCT) on the DCT coefficients generated in step S1003, so as to generate block data (S1004).

Then, the feature analyzing unit 210 analyzes the features (an edge type, a texture type, a skin color types, and the likes) of the block data generated in step S1004. The feature analyzing unit 210 adds feature data (the types of features and the location information) that is the analysis results to the block data (S1005). Then, the quantization parameter generating unit 212 then refers to the feature data and the conversion parameters, and converts the quantization matrix into the matrix shown in FIG. 5(e) (S1006). The method of converting the quantization matrix has already been described in the description of the quantization parameter generating unit 212, with reference to FIG. 9.

Then, using the quantization matrix (see FIG. 5(e)) generated in step S1006, the inverse quantizing unit 206 again performs inverse quantization on the quantized data generated in step S1002, so as to generate DCT coefficients (S1007). Then, the inverse DCT unit 208 carries out an inverse discrete cosine transform (an inverse DCT) on the DCT coefficients, so as to generate block data (S1008).

Then, the image decoding device 200 outputs the block data generated in step S1008 to the display device 300, and ends the variable-length decoding processing in accordance with the third embodiment of the present invention (S1009).

Alternatively, in step S1009, the image decoding device 200 may output each set of block data to the display device 300 separately from the other sets of block data. Alternatively, the image decoding device 200 may integrate sets of block data to generate image data, and output each set of image data to the display device 300 separately from the other sets of image data.

In accordance with the third embodiment of the present invention, the quantization matrix portion of each macro-block for inversion quantization is generated through a conversion, based on conversion parameters. Therefore, even in a case where the quantization matrix obtained prior to a conversion, the conversion parameters, and the variable-length coded data with a small coding amount only structured with quantized data are decoded, it is possible to output block data with little image quality degradation with respect to the original image data.

What is claimed is:

1. An image coding device comprising:
a block dividing unit that divides image data into blocks, so as to generate block data, each of the blocks being formed with a plurality of pixels;
a DCT unit that carries out a discrete cosine transform on the block data, so as to generate DCT coefficients;
a feature analyzing unit that analyzes the block data, so as to generate feature data;
a quantization parameter generating unit that refers to the block data and the feature data, and generates a quantization matrix;
a quantizing unit that quantizes the DCT coefficients with the use of the quantization matrix, so as to generate quantized data; and
a variable-length coding unit that performs variable-length coding on the quantized data, so as to generate variable-length coded data.

2. The image coding device according to claim 1, wherein the quantization parameter generating unit generates the quantization matrix based on the feature data generated by the feature analyzing unit, so that features of the block data generated by the block dividing unit can be maintained.

3. The image coding device according to claim 1, wherein:
the quantization parameter generating unit refers to the block data and the feature data to generate the quantization matrix and conversion parameters, and carries out a conversion on the quantization matrix with the use of the conversion parameters;
the quantizing unit quantizes the DCT coefficients with the use of the converted quantization matrix, so as to generate the quantized data; and
the variable-length coding unit performs variable-length coding on the quantized data and the conversion parameters, so as to generate the variable-length coded data.

4. The image coding device according to claim 3, further comprising
an inverse quantizing unit that performs inverse quantization on the quantized data, so as to generate block data,
wherein:
the feature analyzing unit analyzes features of the block data generated by the block dividing unit and features of the block data generated by the inverse quantizing unit, and determines whether a feature difference between the two sets of block data is within an allowed range;
the quantization parameter generating unit modifies the conversion parameters when the feature difference between the two sets of block data is not within the allowed range, and carries out a conversion on the quantization matrix with the use of the modified conversion parameters; and
the variable-length coding unit performs variable-length coding on the quantized data and the conversion parameters when the feature difference between the two sets of block data is within the allowed range, and generates the variable-length coded data.

5. The image coding device according to claim 4, which is connected to an input device that receives an instruction to set a compression-first mode in which priority is put on a compression rate over image quality or a quality-first mode in which priority is put on image quality over a compression rate,
wherein:
when the input device receives an instruction to set the compression-first mode, and the feature difference between the two sets of block data is not within the allowed range, the quantization parameter generating unit modifies the conversion parameters, and carries out a conversion on the quantization matrix with the use of the modified conversion parameters; and
when the input device receives an instruction to set the quality-first mode, and the feature difference between the two sets of block data is not within the allowed range, the quantization parameter generating unit makes a predetermined number of modifications to the conversion parameters until the feature difference falls within the allowed range, and carries out a conversion on the quantization matrix with the use of the modified conversion parameters.

6. The image coding device according to claim 1, wherein the quantization parameter generating unit refers to the feature data so as to replace pixels of non-feature portions among pixels in the block data with non-feature pixels, and refers to the replaced block data and the feature data so as to generate the quantization matrix.

7. The image coding device according to claim 6, wherein:
the quantization parameter generating unit refers to the block data and the feature data so as to generate the quantization matrix and conversion parameters, and carries out a conversion on the quantization matrix with the use of the conversion parameters;
the quantizing unit quantizes the DCT coefficients with the use of the converted quantization matrix, so as to generate the quantized data; and
the variable-length coding unit performs variable-length coding on the quantized data and the conversion parameters, so as to generate the variable-length coded data.

8. The image coding device according to claim 7, further comprising
an inverse quantizing unit that performs inverse quantization on the quantized data, so as to generate block data,
wherein:
the feature analyzing unit analyzes features of the block data generated by the block dividing unit and features of the block data generated by the inverse quantizing unit, and determines whether a feature difference between the two sets of block data is within an allowed range;
the quantization parameter generating unit modifies the conversion parameters when the feature difference between the two sets of block data is not within the allowed range, and carries out a conversion on the quantization matrix with the use of the modified conversion parameters; and
the variable-length coding unit performs variable-length coding on the quantized data and the conversion parameters when the feature difference between the two sets of block data is within the allowed range, and generates the variable-length coded data.

9. The image coding device according to claim 8, which is connected to an input device that receives an instruction to set a compression-first mode in which priority is put on a compression rate over image quality or a quality-first mode in which priority is put on image quality over a compression rate,
wherein:
when the input device receives an instruction to set the compression-first mode, and the feature difference between the two sets of block data is not within the allowed range, the quantization parameter generating unit modifies the conversion parameters, and carries out a conversion on the quantization matrix with the use of the modified conversion parameters; and
when the input device receives an instruction to set the quality-first mode, and the feature difference between the two sets of block data is not within the allowed range, the quantization parameter generating unit makes a predetermined number of modifications to the conversion parameters until the feature difference falls within the allowed range, and carries out a conversion on the quantization matrix with the use of the modified conversion parameters.

10. An image coding method comprising:
generating block data by dividing image data into blocks, each of the blocks being structured with a plurality of pixels;
generating DCT coefficients by carrying out a discrete cosine transform on the block data;
generating feature data by analyzing the block data;
generating a quantization matrix, with reference to the block data and the feature data;
generating quantized data by quantizing the DCT coefficients with the use of the quantization matrix; and
generating variable-length coded data by performing variable-length coding on the quantized data.

11. The image coding method according to claim 10, wherein the generating the quantization matrix includes generating the quantization matrix based on the feature data, so that features of the block data can be maintained.

12. The image coding method according to claim 10, wherein:
the generating the quantization matrix includes referring to the block data and the feature data to generate the quantization matrix and conversion parameters, and carrying out a conversion on the quantization matrix with the use of the conversion parameters;
the generating the quantized data includes quantizing the DCT coefficients with the use of the converted quantization matrix, so as to generate the quantized data; and
the generating the variable-length coded data includes performing variable-length coding on the quantized data and the conversion parameters, so as to generate the variable-length coded data.

13. The image coding method according to claim 12, further comprising
performing inverse quantization on the quantized data, so as to generate block data,
wherein:
the generating the feature data includes analyzing features of the block data generated by dividing the image data and features of the block data generated by performing inverse quantization on the quantized data, and determining whether a feature difference between the two sets of block data is within an allowed range;
the generating the quantization matrix includes modifying the conversion parameters when the feature difference between the two sets of block data is not within the allowed range, and carrying out a conversion on the quantization matrix with the use of the modified conversion parameters; and
the generating the variable-length coded data includes performing variable-length coding on the quantized data and the conversion parameters when the feature difference between the two sets of block data is within the allowed range, so as to generate the variable-length coded data.

14. The image coding method according to claim 13, wherein:
when an instruction to set a compression-first mode in which priority is put on a compression rate over image quality is received, and the feature difference between the two sets of block data is not within the allowed range, the generating the quantization matrix includes modifying the conversion parameters, and carrying out a conversion on the quantization matrix with the use of the modified conversion parameters; and
when an instruction to set a quality-first mode in which priority is put on image quality over a compression rate is received, and the feature difference between the two sets of block data is not within the allowed range, the generating the quantization matrix includes making a predetermined number of modifications to the conversion parameters until the feature difference falls within the allowed range, and carrying out a conversion on the quantization matrix with the use of the modified conversion parameters.

15. The image coding method according to claim 10, wherein:
the generating the quantization matrix includes referring to the feature data so as to replace pixels of non-feature portions among pixels in the block data with non-feature pixels, and refers to the replaced block data and the feature data so as to generate the quantization matrix.

16. The image coding method according to claim 15, wherein:
the generating the quantization matrix includes referring to the block data and the feature data to generate the quantization matrix and conversion parameters, and carrying out a conversion on the quantization matrix with the use of the conversion parameters;
the generating the quantized data includes quantizing the DCT coefficients with the use of the converted quantization matrix, so as to generate the quantized data; and
the generating the variable-length coded data includes performing variable-length coding on the quantized data and the conversion parameters, so as to generate the variable-length coded data.

17. The image coding method according to claim 16, further comprising
performing inverse quantization on the quantized data, so as to generate block data,
wherein:
the generating the feature data includes analyzing features of the block data generated by dividing the image data and features of the block data generated by performing inverse quantization on the quantized data, and determining whether a feature difference between the two sets of block data is within an allowed range;
the generating the quantization matrix includes modifying the conversion parameters when the feature difference between the two sets of block data is not within the allowed range, and carrying out a conversion on the quantization matrix with the use of the modified conversion parameters; and
the generating the variable-length coded data includes performing variable-length coding on the quantized data and the conversion parameters when the feature difference between the two sets of block data is within the allowed range, so as to generate the variable-length coded data.

18. The image coding method according to claim 17, wherein:
when an instruction to set a compression-first mode in which priority is put on a compression rate over image quality is received, and the feature difference between the two sets of block data is not within the allowed range, the generating the quantization matrix includes modifying the conversion parameters, and carrying out a conversion on the quantization matrix with the use of the modified conversion parameters; and
when an instruction to set a quality-first mode in which priority is put on image quality over a compression rate is received, and the feature difference between the two sets of block data is not within the allowed range, the generating the quantization matrix includes making a predetermined number of modifications to the conversion parameters until the feature difference falls within the allowed range, and carrying out a conversion on the quantization matrix with the use of the modified conversion parameters.

19. An image decoding device comprising:
a decoding unit that decodes variable-length coded data, so as to generate quantized data and conversion parameters;
an inverse quantizing unit that performs inverse quantization on the quantized data with the use of a first quantization matrix, so as to generate first DCT coefficients;
an inverse DCT unit that carries out an inverse discrete cosine transform on the first DCT coefficients, so as to generate first block data;
a feature analyzing unit that analyzes the first block data, and generates feature data; and
a quantization parameter generating unit that refers to the first block data, the feature data, and the conversion parameters, and generates a second quantization matrix,
the inverse quantizing unit performing inverse quantization on the quantized data with the use of the second quantization matrix,
the inverse DCT unit carrying out an inverse discrete cosine transform on the second DCT coefficients, so as to generate second block data.
